(19) United States
(12) Patent Application Publication
(10) Pub. No.: US 2011/0239513 A1
(43) Pub. Date: Oct. 6, 2011

(54) MODULAR RAIL ATTACHMENT SYSTEM

(76) Inventor: James A. Sandman, Beaverton, OR (US)

(21) Appl. No.: 12/753,543

(22) Filed: Apr. 2, 2010

(51) Int. Cl. F41C 27/00; B23P 11/00

(52) U.S. Cl. 42/90; 29/525.01

(57) ABSTRACT

A modular rail attachment hand guard system can fit aftermarket gas piston equipped military and sporting rifles. The modular rail attachment hand guard system may include a removable upper section, the upper section having two lower longitudinal sides, and a lower section where the lower section has at least two longitudinal sides. The removable upper section may be secured via a single fastener and the removable upper section can be removed after the single fastener is released.

### BACKGROUND OF THE INVENTION

1. Field of the Invention

A modular rail attachment hand guard fits aftermarket gas piston equipped military and sporting rifles.

2. Description of the Related Art

Rifles are typically fired using two hands. One hand is placed near the trigger assembly and the other is typically placed down the barrel from the trigger assembly.

Rifles conventionally include a stock fabricated of wood or synthetic material. The stock typically includes a fore stock which extends some distance down the barrel. The fore stock is grasped by the shooter to provide balance and facilitate aiming the rifle. The shooter's hand is protected from the heat of the barrel during firing by the fore stock.

Other rifles do not include a single stock, but have a receiver to which a butt stock and a barrel are attached. The hand of a shooter is then protected from the barrel by a hand guard attached to the barrel.

One of the problems with most aftermarket hand guards currently sold is that nearly all of them are not designed to accommodate the larger dimensions of aftermarket gas piston kits. This namely applies to gas piston equipped AR15/M4 military and sporting rifles.

Current conventional hand guards generally utilize two or more screws and or clamps/brackets to attach the top cover which conceals and protects the gas piston components. Some even require removal of the entire hand guard. These can be overly complicated and tend to increase lost parts and added maintenance time. Moreover, most of the current hand guards are large in diameter and bulky.

There is accordingly a need for improved gas piston specific hand guard technologies.

### SUMMARY OF THE INVENTION

An embodiment of a modular rail attachment system for use on a rifle may include an upper section referred to as the top cover, the upper section having two lower longitudinal sides, at least one protrusion extending from each of the two longitudinal sides. The system may also include a lower section referred to as the chassis, the lower section having at least two longitudinal sides, each longitudinal side of the lower section having a slot corresponding to each protrusion of the upper section. The upper section and the lower section may be secured via a single fastener.

An embodiment of a method of assembling a modular rail attachment system may include providing a removable upper section which has two lower longitudinal sides, assembling a lower section to the upper section, the lower section having at least two longitudinal sides, and securing the removable upper section to the lower section via a single fastener, where the removable upper section can be removed after the single fastener is released.

It is to be understood that both the foregoing general description and the following detailed description are exemplary and explanatory and are intended to provide further explanation of the claimed embodiments.

### BRIEF DESCRIPTION OF THE DRAWING FIGURES

The accompanying drawings are included to provide a further understanding of the embodiments. The drawings illustrate embodiments and together with the description serve to explain the principles of the embodiments

FIG. 1 is a perspective view showing an example of the rifle with an assembled modular rail attachment system according to an embodiment;

FIG. 2 is an exploded perspective view showing an example of the modular rail attachment system according to an embodiment;

FIG. 3 is a closer perspective view showing an example of one side of the upper cover and lower chassis according to an embodiment;

FIG. 4 is a closer perspective view showing an example of the locking tabs of the upper cover and the corresponding recession of the lower chassis according to an embodiment;

FIG. 5 is a closer perspective view showing an example of assembling the extending cover and the lower chassis according to an embodiment;

FIG. 6A is a rear view showing an example of the modular rail attachment system according to an embodiment;

FIG. 6B is a front view showing an example of the modular rail attachment system according to an embodiment;

FIG. 7 is an exploded perspective view showing an example of the modular rail attachment system according to an embodiment;

FIG. 8 is a rear view showing an example of attaching mechanism according to an embodiment.

### DETAILED DESCRIPTION

Advantages of the embodiments will become more apparent from the detailed description given hereinafter. However, it should be understood that the detailed description and specific examples, while indicating preferred embodiments, are given by way of illustration only, since various changes and modifications within the spirit and scope of the embodiments will become apparent to those skilled in the art from this detailed description.

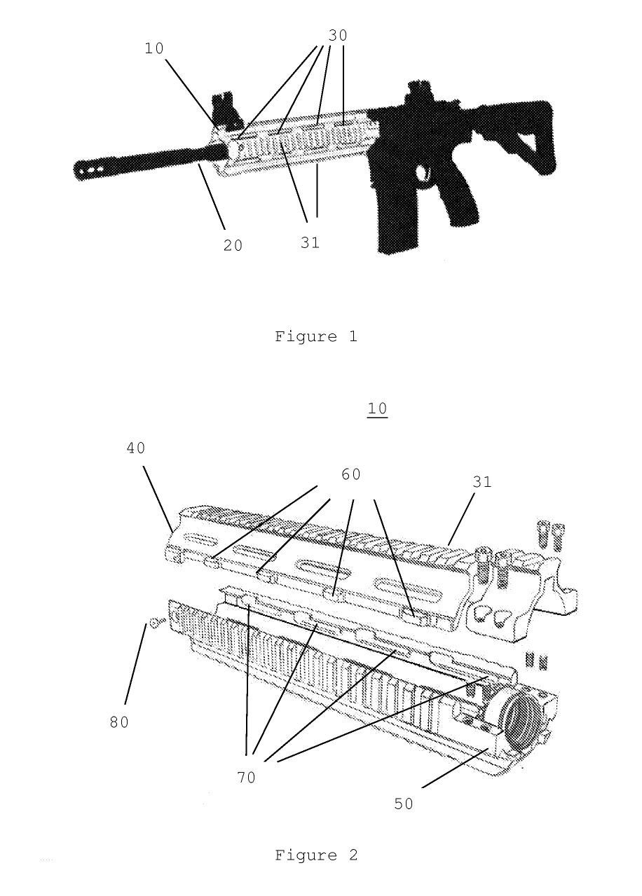

In an embodiment shown in FIG. 1, a Modular Rail Attachment System (MRAS) Gas Piston (GP) may be a free floating modular rail hand guard intended to fit aftermarket gas piston equipped military and sporting rifles such as the AR15/M4 rifle 20. The MRAS GP may be about ten inches long, but is not restricted to this size. This MRAS GP is not limited to use on gas piston equipped rifles but will fit and may be attached to all rifles with standard gas impingement systems.

The MRAS GP can contain four Mil-Spec 1913 picatinney rails 31 in a space designed within the MRAS GP. The picatinney rails may be about 10 inches long, but are not restricted to this length. The entire system can be constructed of 6061 T6 aluminum and is hard coat anodized per Mil-Spec standards. The material may be one that has low specific weight. Other metals can be used, such as titanium, steel, aluminum alloys, etc. The material is not limited to aluminum or metal or even plastic may also be used.

There may be about four cooling slots 30 of approximately equal length placed between the picatinney rails 31 along the longitudinal axis of the MRAS GP for a total of about sixteen cooling slots. The number and shape of the cooling slots 30 can be varied according to the length, shape or material of the MRAS GP.

In FIG. 2, one of the features of the MRAS GP is shown. The MRAS GP may have a removable upper cover 40 that is secured with the lower chassis 50 via only a single fastener, such as a set screw 80. After removing the fastener, the upper cover can be removed from the system. This allows for quick and easy removal/installation of the upper cover. This is advantageous because gas piston equipped rifles require periodic cleaning and maintenance of the gas piston.

The screw can be of a type that can be unscrewed with a flat screwdriver, a Philips screwdriver or an Allen wrench. Also the fastener need not be a screw and other fastening arrangements including clasps, VELCRO (a synthetic material sold in ribbon, sheet, or piece goods form, said material having a complement of parts which adhere to each other when pressed together and adapted for use as a fastener) etc. may be used.

In order to assemble the removable upper cover, the upper cover 40 may first be attached with the lower chassis by an attaching mechanism. One of the attaching mechanisms is shown in FIG. 2 which is the locking tab and slot arrangement. The tabs and slots may be arranged on the upper cover and lower chassis separately, for example tabs 60 and slots 70. After sliding locking tabs of the upper cover into slots of lower chassis, the upper cover is attached to the lower chassis. However, the slots can alternatively be on the upper cover and the tabs on the lower chassis.

In the tab and slot arrangements of the MRAS GP, in addition to locking tabs 60 on the lateral sides of the covers 40, the upper cover 40 may contain two larger projections on the front end.

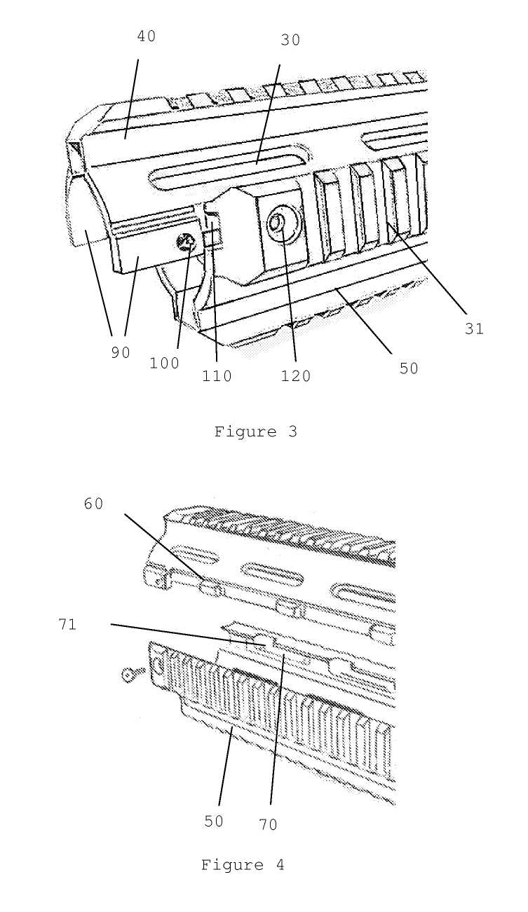

As shown in FIG. 3, these projections can also be referred to as “indexing lugs” 90. The indexing lug 90 on the left front corner has been drilled with a hole 100 and tapped to accept a set screw, but the lug on the right front corner has not. On the front end of the lower chassis 50, a recess 110 corresponding to the lug is designed to match the indexing lugs 90. The opening of the recess is at the front end of the MRAS GP and the recess may be longitudinal.

When assembling, the indexing lugs 90 and the recessions 110 in the lower chassis 50 have been off-set. The off-set places the lugs outside of the upper cover and ahead of the front edge of the lower chassis.

As shown in FIG. 4, the locking tabs 60 of the upper cover are pushed down into the recessed openings 71 of their respective slots 70 in the lower chassis 50. Thus, the locking tabs 60 of the top cover 40 have been placed at the end of the slots 70 in the lower chassis 50. The end of the recessed openings 71 locates at a top surface of the lower chassis and the lots 70 are longitudinal.

The upper cover is then slid back such that the locking tabs 60 rest in slots 70 and the indexing lugs 90 rest in recesses 110 of the lower chassis 50. The upper cover and lower chassis now are attached.

A single set screw 80 then passes through a beveled hole 120 in the front left lower chassis and into the threaded hole 100 in the left locking lug of the upper cover. Other fastener mechanisms can also be used to fix the upper cover and the lower chassis, such as a pair of buckle or a pin. Reversing the above steps then can remove the upper chassis.

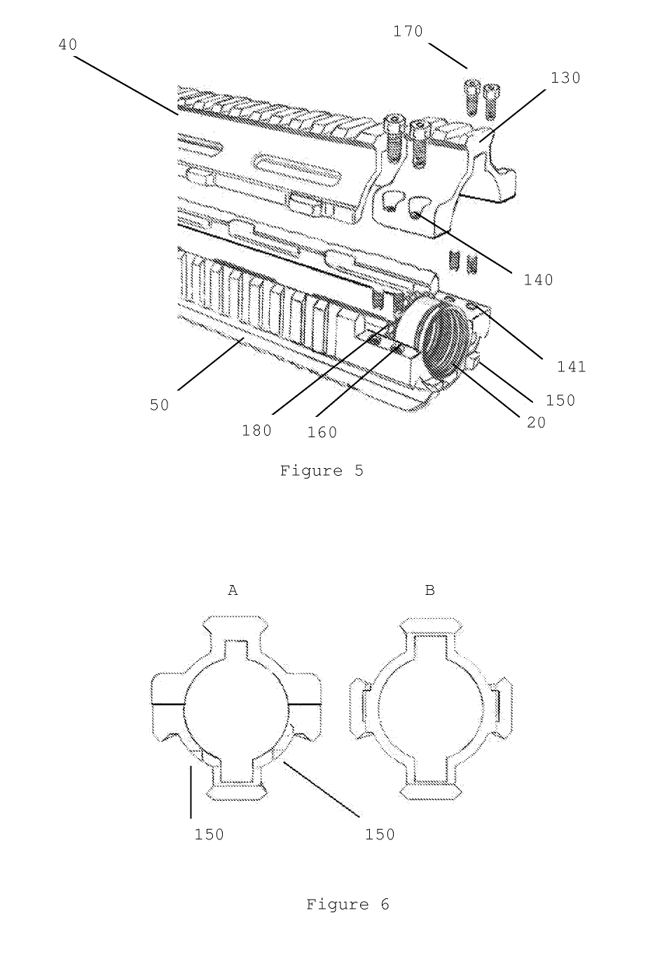

In FIG. 5, the whole MRAS GP is attached to the firearm at the rear end of the MRAS GP. In this embodiment, an upper clamp which is an extension of the upper cover is introduced here.

In FIG. 5, the firearm 20 is placed in the lower chassis 50 which a groove cut into it in order to accommodate the teeth of the barrel nut 180. In the mean time, the upper clamp is placed on the top portion of the barrel nut 160 which also has a corresponding groove and its slotted rail is aligned with that of the rifle receiver. The holes 140 of the upper clamp are aligned to the threaded holes 141 of the lower chassis. The upper clamp 130 is then bolted to the lower cover and forms a 360 degree clamp around the barrel nut 160 of the firearm 20. Four screws 170 are installed and tightened. However, there may other numbers of screws used for attachment.

Once this step is completed, the lower chassis may never need to be removed from the firearm 20 for general maintenance and only the upper cover 40, as described above, need to be removed from the firearm.

Moreover, two small protrusions 150, referred to anti-rotation lugs, are shown in the FIG. 5 and FIG. 6A. When the lower chassis is assembled with the aftermarket gas, they butt up against the sides of the receiver of the rifle (not shown in the drawing). The anti-rotation lugs help eliminate the chance that the barrel nut of the rifle could be loosened when the hand guard is twisted counter-clockwise and thus increase the safety.

In the above embodiments, parts of the tabs (60, 70) may be replaced by attaching grooves, which is also able to attach the upper cover and the lower chassis.

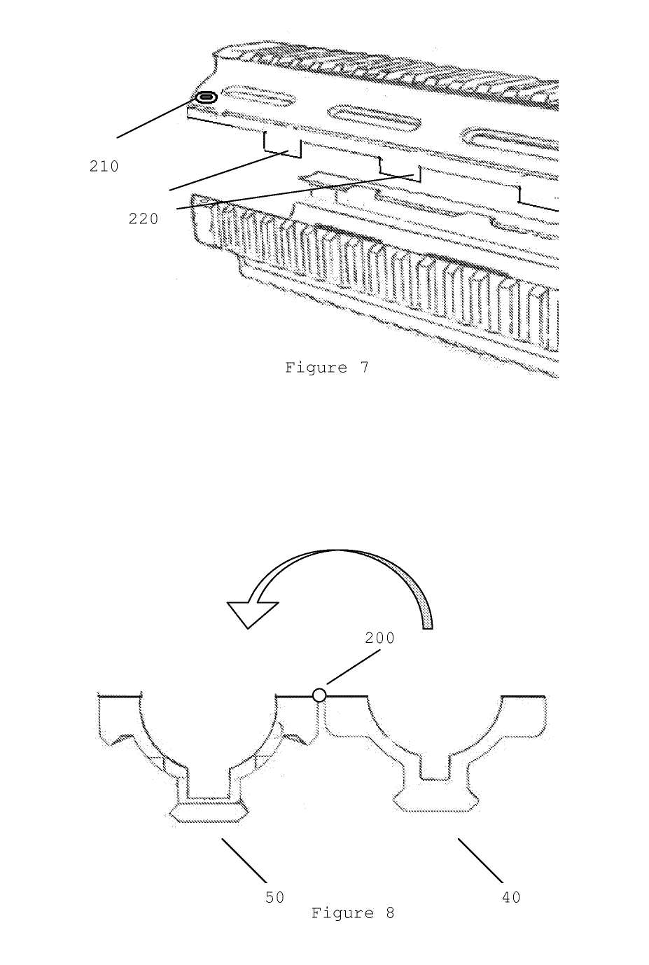

In the other embodiments, locking tabs (60, 70) can also be replaced by other shapes of protrusions. In FIG. 7, protrusions 220 are used as an attaching mechanism. In this embodiment, the holes 210 of covers are designed on the top surface of the upper cover.

In the other embodiments, all the fastener mechanism can be used to replace the screw, such as buckles, brackets or clamps etc.

In FIG. 8, one of the other embodiments is shown. The attaching mechanism may also be a hinge. A hinge 200 connects the removable upper cover and lower chassis at one side.

It is to be understood that the foregoing descriptions and specific embodiments shown herein are merely illustrative of the best mode and the principles thereof, and that modifications and additions may be easily made by those skilled in the art without departing for the spirit and scope of the embodiments, which is therefore understood to be limited only by the scope of the appended claims.

What is claimed is:

1. A modular rail attachment system, comprising:
a removable upper section, the upper section having two lower longitudinal sides; and
a lower section, the lower section having at least two longitudinal sides,
wherein the removable upper section is secured via a single fastener and the removable upper section can be removed after the single fastener is released.

2. The modular rail attachment system of claim 1, wherein the removable upper section attached to the lower section via an attaching mechanism.

3. The modular rail attachment system of claim 2, wherein the attaching mechanism comprises at least a protrusion extending from each of the two longitudinal sides of the upper section and at least one slot corresponding to each said protrusion of the upper section at each longitudinal side of the lower section.

4. The modular rail attachment system of claim 3, wherein there are four slots and four protrusions.

5. The modular rail attachment system of claim 3, wherein each protrusion and corresponding slot are offset so that when the top section is pushed down and then pushed back, respective holes in the front of the upper section and the lower section are aligned, so as to accept the single fastener.

6. The modular rail attachment system of claim 1, wherein the first attaching mechanism includes two lugs at an end of the upper section, and one of said lugs is configured to accept the single fastener.

7. The modular rail attachment system of claim 1, wherein the single fastener is a set screw.

8. The modular rail attachment system of claim 1, wherein the upper portion includes an integrated section of at least two picatinney rail, and at least one cooling slot is located between the at least two picatinney rails.

9. The modular rail attachment system of claim 8, wherein there are four picatinney rails.

10. The modular rail attachment system of claim 1, further comprising an extending section, which has an internal arc, bolted on a top surface of the rear end of the lower section to form a clamp around a barrel nut of a firearm.

11. The modular rail attachment system of claim 10, wherein the extending section connects to the lower section via a second fastener.

12. The modular rail attachment system of claim 10, wherein the upper section connects to the extending section via the single fastener.

13. The modular rail attachment system of claim 2, wherein the attaching mechanism comprises a hinge.

14. The modular rail attachment system of claim 2, wherein the attaching mechanism comprises attaching grooves.

15. The modular rail attachment system of claim 1, wherein the modular rail attachment system is formed from aluminum.

16. A method of assembling a modular rail attachment system comprising:
providing a removable upper section which has two lower longitudinal sides;
assembling a lower section to the upper section, the lower section having at least two longitudinal sides; and
securing the removable upper section to the lower section via a single fastener, wherein
the removable upper section can be removed after the single fastener is released.

17. The method of assembling the modular system of claim 16, further comprising bolting an extending section, which has an internal arc, to the lower section.

18. The method of assembling the modular system of claim 16, wherein the removable upper section attached to the lower section via an attaching mechanism.

19. The method of assembling the modular system of claim 18, wherein the attaching mechanism comprises at least a protrusion extending from each of the two longitudinal sides of the upper section and at least one slot corresponding to each said protrusion of the upper section at each longitudinal side of the lower section.

20. The method of assembling the modular system of claim 19, wherein there are four slots and four protrusions.
